(19) United States
(12) Patent Application Publication
(10) Pub. No.: US 2011/0074947 A1
(43) Pub. Date: Mar. 31, 2011

(54) Speed Measurement System With Dynamic Image Capture And Speed Measurement System With Static Image Capture

(75) Inventor: Ta-Chiun KUAN, Hsinchu (TW)

(73) Assignee: Chi San Technology CO., LTD.

(21) Appl. No.: 12/853,661

(22) Filed: Aug. 10, 2010

(30) Foreign Application Priority Data
Sep. 28, 2009 (TW) 098132708

(51) Int. Cl. H04N 7/18

(52) U.S. Cl. 348/135; 348/E07.085

(57) ABSTRACT

A speed measurement system with dynamic image capture includes a dynamic camera, a velocimeter and an image combining unit. The dynamic camera is adapted to continuously shoot a predetermined region to capture a first dynamic image. The velocimeter is adapted to measure a moving speed of a moving object in the predetermined region. The image combining unit is adapted to combine the first dynamic image and the moving speed of the moving object into a second dynamic image. The speed measurement system with dynamic image capture achieves a speed measurement function and a dynamic image capture function. Further, a speed measurement system with static image capture is also provided.

### CROSS-REFERENCE TO RELATED APPLICATIONS

This application is based upon and claims the benefit of priority from the prior Taiwanese Patent Application No. 098132708, filed Sep. 28, 2009, the entire contents of which are incorporated herein by reference.

### BACKGROUND

1. Field of the Invention

The present invention relates to a speed measurement system with image capture, and particularly to a speed measurement system with dynamic image capture and a speed measurement system with static image capture.

2. Description of Related Art

Recently, outdoor surveillance systems have been widely used at busy traffic intersections for providing roads information to related organizations in real time or providing important clues to the police.

However, the conventional surveillance system only has a dynamic image capture function. It is necessary to dispose a speed measurement system with static image capture to detect whether a speed of a vehicle exceeds a speed limit or not. The conventional speed measurement system with static image capture includes a velocimeter and a static camera. When the speed of the vehicle exceeds the speed limit, the static camera shoots the vehicle to capture a static image of the vehicle. Moreover, when shooting, a shoot range of the static camera not only covers the vehicle but also covers a speed display device of the velocimeter. Such that, the static image captured by the static camera can include a vehicle image and a moving speed of the vehicle. However, a portion of the static image is an image of the speed display device.

In the conventional technique, not only a cost of the surveillance system is needed but also a cost of the speed measurement system with static image capture is needed because the conventional surveillance system can not provide a speed measurement function.

### BRIEF SUMMARY

The present invention provides a speed measurement system with dynamic image capture to achieve a speed measurement function and a dynamic image capture function.

The present invention further provides a speed measurement system with static image capture to capture a static image without an image of a speed display device of a velocimeter.

To achieve at least one of the above mentioned advantages, the present invention provides a speed measurement system with dynamic image capture. The speed measurement system with dynamic image capture includes a dynamic camera, a velocimeter and an image combining unit. The dynamic camera is adapted to continuously shoot a predetermined region to capture a first dynamic image. The velocimeter is adapted to measure a moving speed of a moving object in the predetermined region. The image combining unit is electrically connected to the dynamic camera and the velocimeter. The image combining unit is adapted to combine the first dynamic image and the moving speed of the moving object into a second dynamic image.

In one embodiment of the present invention, the speed measurement system with dynamic image capture further includes a storage device electrically connected to the image combining unit. The storage device is adapted to store the second dynamic image. Furthermore, in one embodiment, the speed measurement system with dynamic image capture can further include a control unit electrically connected to the velocimeter and the storage device. The control unit is adapted to turn on the storage device when the moving speed of the moving object measured by the velocimeter exceeds a predetermined value.

In one embodiment of the present invention, the speed measurement system with dynamic image capture further includes a display device electrically connected to the image combining unit, wherein the display device is adapted to display the second dynamic image.

In one embodiment of the present invention, the speed measurement system with dynamic image capture further includes a transmission apparatus electrically connected to the image combining unit, wherein the transmission apparatus is adapted to transmit the second dynamic image.

In one embodiment of the present invention, the transmission apparatus includes a wired network apparatus or a wireless network apparatus. In one embodiment, the speed measurement system with dynamic image capture can further include a video server electrically connected between the transmission apparatus and the image combining unit, wherein the video server is adapted to convert a signal type of the second dynamic image into a digital network signal.

In one embodiment of the present invention, the speed measurement system with dynamic image capture further includes a signal converter and a storage device. The signal converter is electrically connected to the image combining unit for converting a signal type of the second dynamic image. The storage device is electrically connected to the signal converter, wherein the storage device is adapted to store the second dynamic image. Moreover, in one embodiment, the speed measurement system with dynamic image capture can further include a control unit electrically connected to the velocimeter and the storage device. The control unit is adapted to turn on the storage device when the moving speed of the moving object measured by the velocimeter exceeds a predetermined value.

In one embodiment of the present invention, the speed measurement system with dynamic image capture further includes a signal converter and a display device. The signal converter is electrically connected to the image combining unit for converting a signal type of the second dynamic image. The display device is electrically connected to the signal converter, wherein the display device is adapted to display the second dynamic image.

In one embodiment of the present invention, the speed measurement system with dynamic image capture further includes a signal converter and a transmission apparatus. The signal converter is electrically connected to the image combining unit for converting a signal type of the second dynamic image. The transmission apparatus is electrically connected to the signal converter, wherein the transmission apparatus is adapted to transmit the second dynamic image. In one embodiment, the speed measurement system with dynamic image capture can further include a video server electrically connected between the transmission apparatus and the signal converter, wherein the video server is adapted to convert a signal type of the second dynamic image into a digital network signal.

In one embodiment of the present invention, the velocimeter includes a laser velocimeter.

To achieve at least one of the above-mentioned advantages, the present invention further provides a speed measurement system with static image capture including a velocimeter, a static camera and an image combining unit. The velocimeter is adapted to measuring a moving speed of a moving object in a predetermined region. The static camera is electrically connected to the velocimeter and is adapted to shoot the moving object to capture a first static image when the moving speed of the moving object measured by the velocimeter exceeding a predetermined value. The image combining unit is electrically connected to the velocimeter and the static camera. The image combining unit is adapted to combine the first static image and the moving speed of the moving object into a second static image.

In one embodiment of the present invention, the speed measurement system with static image capture further includes a storage device electrically connected to the image combining unit, wherein the storage device is adapted to store the second static image.

The speed measurement system with dynamic image capture of the present invention not only includes the dynamic camera but also includes the velocimeter and the image combining unit. The image combining unit is configured to combine the first dynamic image captured by the dynamic camera and the moving speed measured by the velocimeter into the second dynamic image. A speed measurement system with static image capture is not needed due to the speed measurement system with dynamic image capture of the present invention having speed measurement function. Therefore, a cost of the speed measurement system with static image capture can be omitted. Furthermore, in the speed measurement system with static image capture of the present invention, a shoot range of the static camera is not needed to cover a speed display device of the velocimeter due to the image combining unit being capable of combining the first static image captured by the static camera and the moving speed of the moving object measured by the velocimeter into the second static image.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a speed measurement system with dynamic image capture according to an embodiment of the present invention.

FIG. 2 is a block diagram of a speed measurement system with dynamic image capture according to another embodiment of the present invention.

FIG. 3 is a block diagram of a speed measurement system with dynamic image capture according to another embodiment of the present invention.

FIG. 4 is a block diagram of a speed measurement system with dynamic image capture according to another embodiment of the present invention.

FIG. 5 is a block diagram of a speed measurement system with dynamic image capture according to another embodiment of the present invention.

FIG. 6 is a block diagram of a speed measurement system with static image capture according to an embodiment of the present invention.

### DETAILED DESCRIPTION

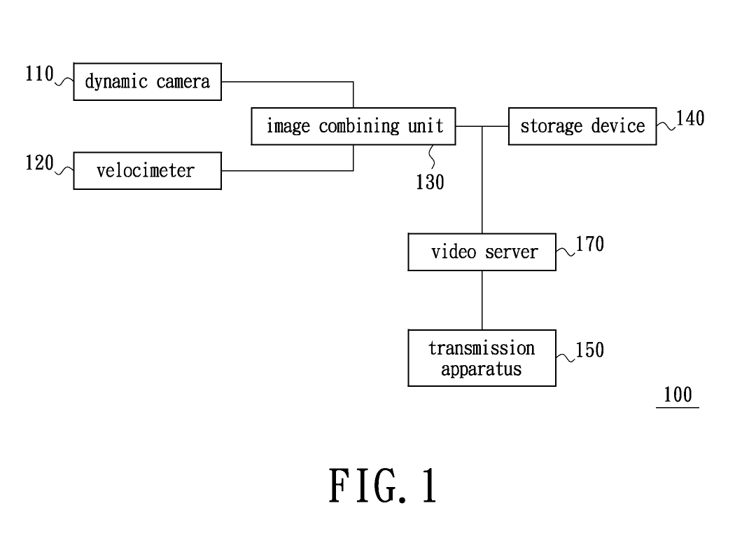

FIG. 1 is a block diagram of a speed measurement system with dynamic image capture according to an embodiment of the present invention. Referring to FIG. 1, the speed measurement system with dynamic image capture 100 of the present embodiment includes a dynamic camera 110, a velocimeter 120 and an image combining unit 130. The dynamic camera 110 is adapted to continuously shoot a predetermined region to capture a first dynamic image. The velocimeter 120 is adapted to measure a moving speed of a moving object such as a vehicle in the predetermined region. The image combining unit 130 is electrically connected to the dynamic camera 110 and the velocimeter 120. The image combining unit 130 is adapted to combine the first dynamic image and the moving speed of the moving object into a second dynamic image. In other words, the second dynamic image shows the first dynamic image and the moving speed of the moving object.

The second dynamic image can be a digital image or an analogy image. The velocimeter 120 can be, but not limited to a laser velocimeter. A signal output to image combining unit 130 from the velocimeter 120 can include a numeral image. Moreover, the image combining unit 130 combines the numeral image into the first dynamic image to form the second dynamic image.

The speed measurement system with dynamic image capture 100 of the present embodiment can further include a storage device 140 electrically connected to the image combining unit 130. The storage device 140 is adapted to store the second dynamic image. More specifically, when the second dynamic image output from the image combining unit 130 is the digital image, the storage device 140 can be a dynamic digital video storing device such as a secure digital memory card (SD memory card), a micro SD memory card or other flash memory card. When the second dynamic image output from the image combining unit 130 is the analogy image, the storage device 140 can be a dynamic analogy video storing device. Moreover, the second dynamic image includes a plurality of continuous frames, wherein the storage device 140, for example, can store at least thirty continuous frames per second.

The speed measurement system with dynamic image capture 100 of the present embodiment can further include a transmission apparatus 150 electrically connected to the image combining unit 130. The transmission apparatus 150 is adapted to transmit the second dynamic image. More specifically, the transmission apparatus 150 can transmit the second dynamic image to a far end monitoring center. Such that, the far end monitoring center can perform actions such as monitoring and storing. Moreover, the second dynamic image can be further provided to a stolen car identification system to identify whether the moving object is a stolen car or not.

The transmission apparatus 150 can be a wired network apparatus, a wireless network apparatus, a cable transmission apparatus, a power over Ethernet (POE) apparatus, a radio frequency carrier transmission apparatus, a power line communication (PLC) apparatus or other type of transmission apparatus. Moreover, the speed measurement system with dynamic image capture 100 can further includes a video server 170 electrically connected between the transmission apparatus 150 and the image combining unit 130. The video server 170 is adapted to convert a signal type of the second dynamic image into another signal type that can be transmitted by the transmission apparatus 150 so as to enable the transmission apparatus 150 to transmit the second dynamic image. For example, in one embodiment that the transmission apparatus 150 is the wired network apparatus or the wireless network apparatus, the video server 150 is adapted to convert the signal type of the second dynamic image into a digital network signal.

The speed measurement system with dynamic image capture 100 of the present embodiment using the velocimeter 120 to provide speed measurement function and using the image combining unit 130 to combine the first dynamic image captured by the dynamic camera 110 and the moving speed of the moving object measured by the velocimeter 120 into the second dynamic image. When the moving speed of the moving object exceeds the predetermined value (e.g. the moving speed of the moving object exceeds the speed limit), a static image of the moving object can be captured to be provided to the related organization, and then the related organization can enforce the law according to the static image. Therefore, the speed measurement system with dynamic image capture 100 of the present invention can achieve the functions of the conventional surveillance system and the conventional speed measurement system with static image capture. Comparing to the total cost of the conventional surveillance system and the conventional speed measurement system with static image capture, the speed measurement system with dynamic image capture 100 has an advantage of low cost. Moreover, the speed measurement system with dynamic image capture 100 of the present embodiment using the image combining unit 130 to combine the first dynamic image and the moving speed of the moving object, so a shoot range of the dynamic camera 110 is not needed to cover a speed display device of the velocimeter 120. Therefore, a monitoring range of the speed measurement system with dynamic image capture 100 can be increased.

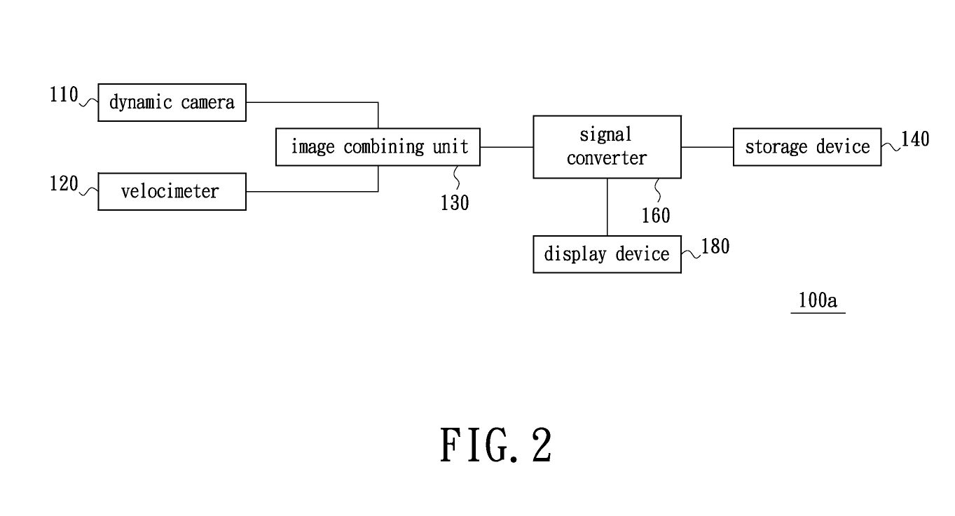

FIG. 2 is a block diagram of a speed measurement system with dynamic image capture according to another embodiment of the present invention. Referring to FIG. 2, the speed measurement system with dynamic image capture 100a of the present embodiment includes a dynamic camera 110, a velocimeter 120, an image combining unit 130, a signal converter 160, a storage device 140 and a display device 180, wherein the functions of the dynamic camera 110, the velocimeter 120 and the image combining unit 130 of the speed measurement system with dynamic image capture 100a are the same with that of the speed measurement system with dynamic image capture 100, and are not described herein. Moreover, the signal converter 160 is electrically connected to the image combining unit 130 to convert an image type of the second dynamic image. More specifically, when the second dynamic image output from the image combining unit 130 is a digital image, the signal converter 160 is used to convert the second dynamic image into an analogy image. When the second dynamic image output from the image combining unit 130 is an analogy image, the signal converter 160 is used to convert the second dynamic image into a digital image. Moreover, the storage device 140 is electrically connected to the signal converter 160 and the storage device 140 is adapted to store the second dynamic image. The display device 180 is electrically connected to the signal converter 160 and the display device 180 is adapted to display the second dynamic image.

The main advantages of the speed measurement system with dynamic image capture 100a of the present embodiment are similar to that of the speed measurement system with dynamic image capture 100, and are not described herein. Moreover, in the present embodiment, one of the storage device 140 and the display device 180 can be omitted.

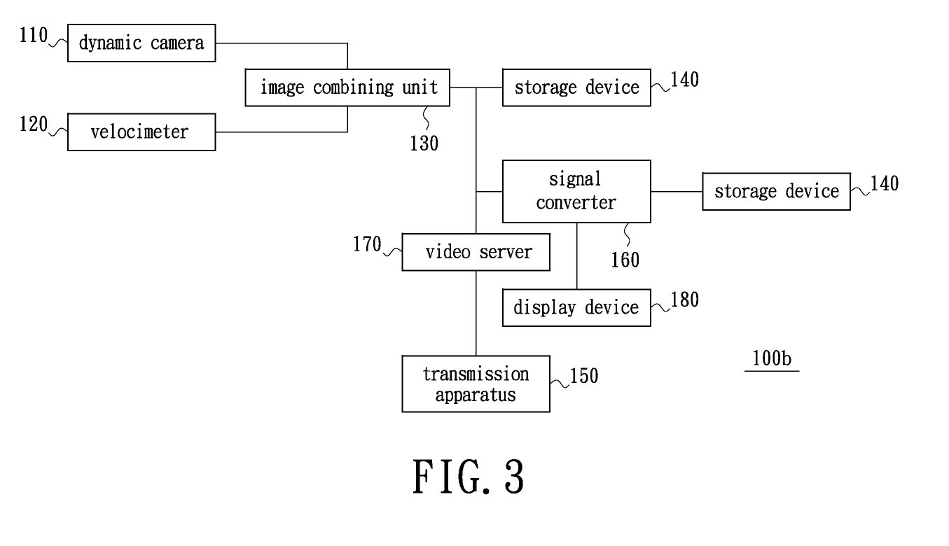

FIG. 3 is a block diagram of a speed measurement system with dynamic image capture according to another embodiment of the present invention. Referring to FIG. 3, the speed measurement system with dynamic image capture 100b of the present embodiment integrates the components of the speed measurement system with dynamic image capture 100 and the speed measurement system with dynamic image capture 100a into the same system.

The main advantages of the speed measurement system with dynamic image capture 100b of the present embodiment are similar to that of the speed measurement system with dynamic image capture 100, and are not described herein. Furthermore, one of the two storage devices 140 in the present embodiment can be omitted.

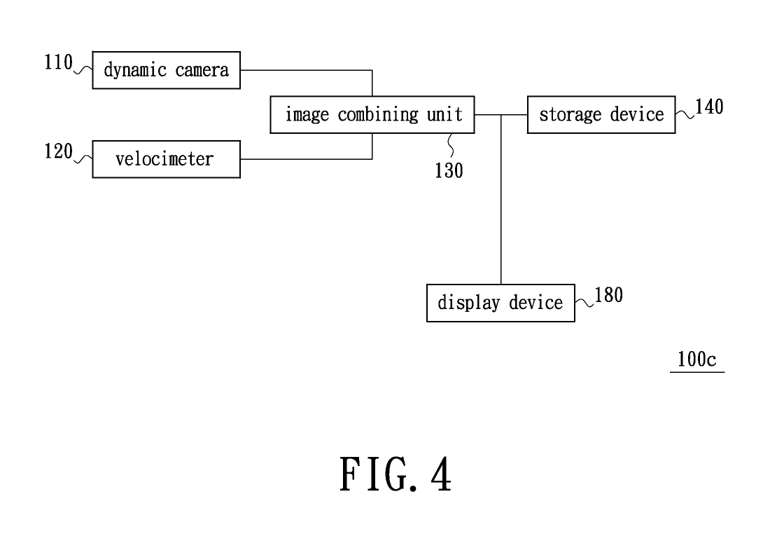

FIG. 4 is a block diagram of a speed measurement system with dynamic image capture according to another embodiment of the present invention. Referring to FIG. 4, the speed measurement system with dynamic image capture 100c of the present embodiment includes a dynamic camera 110, a velocimeter 120, an image combining unit 130, a storage device 140 and a display device 180, wherein the functions of the dynamic camera 110, the velocimeter 120 and the image combining unit 130 of the speed measurement system with dynamic image capture 100c are the same with that of the speed measurement system with dynamic image capture 100, and are not described herein. Moreover, the display device 180 is electrically connected to the image combining unit 130. The display device 180 is adapted to display the second dynamic image.

The main advantages of the speed measurement system with dynamic image capture 100b of the present embodiment are similar to that of the speed measurement system with dynamic image capture 100, and are not described herein.

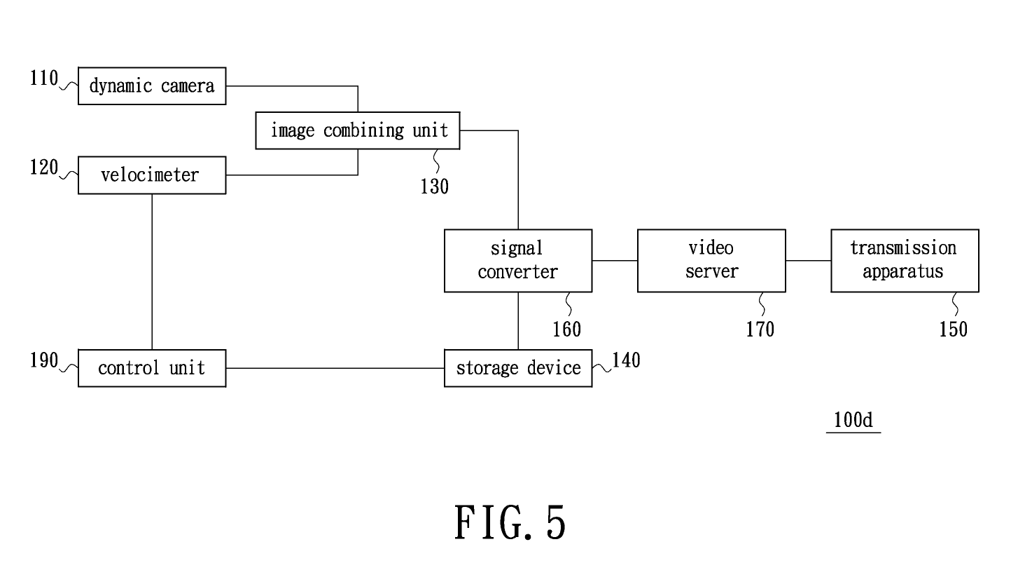

FIG. 5 is a block diagram of a speed measurement system with dynamic image capture according to another embodiment of the present invention. Referring to FIG. 5, the speed measurement system with dynamic image capture 100d of the present embodiment includes a dynamic camera 110, a velocimeter 120, an image combining unit 130, a storage device 140, a transmission apparatus 150, a signal converter 160, a video server 170 and a control unit 190, wherein the functions of the dynamic camera 110, the velocimeter 120, the image combining unit 130, the storage device 140, the transmission apparatus 150, the signal converter 160 and the video server 170 of the speed measurement system with dynamic image capture 100d are the same with that of the above-mentioned embodiments, and are not described herein.

The control unit 190 is electrically connected to the velocimeter 120 and the storage device 140. The control unit 190 is adapted to turn on the storage device 140 when the moving speed of the moving object measured by the velocimeter 120 exceeds the predetermined value. In other words, the control unit 190 turns on the storage device 140 for a while to store the second dynamic image when the moving object exceeding the speed limit is detected by the velocimeter 120. More specifically, the control unit 190, for example, turns off the storage device 140 after the moving object leaving the region shot by the dynamic camera 110 (i.e. the predetermined region) for three seconds.

The speed measurement system with dynamic image capture 100d of the present embodiment uses the control unit 190 to turn off or turn on the storage device 140, so the storage device 140 stores the second dynamic image only while the moving object exceeding the speed limit. Such that, storage space of the storage device 140 can be saved.

It is noted that the control unit 190 also can be applied to the above-mentioned speed measurement system with dynamic image capture 100a, 100b or 100c.

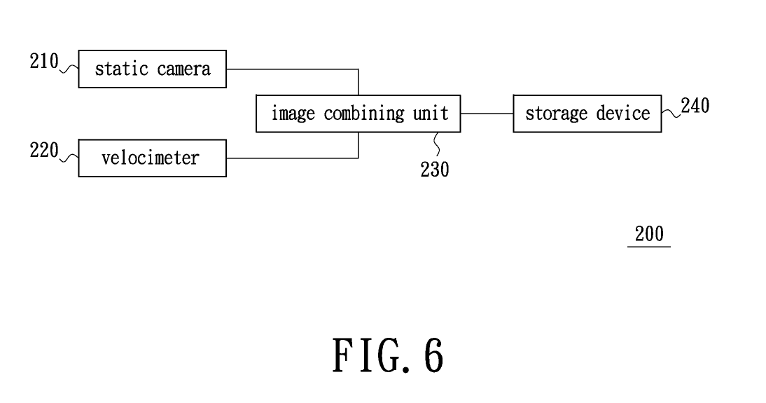

FIG. 6 is a block diagram of a speed measurement system with static image capture according to an embodiment of the present invention. Referring to FIG. 6, the speed measurement system with static image capture 200 of the present embodiment includes a static camera 210, a velocimeter 220 and an image combining unit 230. The velocimeter 220 is adapted to measure a moving speed of a moving object in a predetermined region. The static camera 210 is electrically connected to the velocimeter 220, and the image combining unit 230 is electrically connected to the velocimeter 220 and the static camera 210. When a moving speed of a moving object such as a vehicle measured by the velocimeter 220 exceeds a predetermined value (i.e. the moving speed of the moving object exceeds a speed limit), the static camera 210 shoots the moving object to capture a first static image. The image combining unit is adapted to combine the first static image and the moving speed of the moving object into a second static image. In other words, the second static image shows the first static image and the moving speed of the moving object.

The second static image is, for example, a digital image. Moreover, the speed measurement system with static image capture 200 can further include a storage device 240 electrically connected to the image combining unit 230. The storage device 240 is adapted to store the second static image.

The speed measurement system with static image capture 200 of the present embodiment uses the image combining unit 230 to combining the first static image captured by the static camera 210 and the moving speed of the moving object measured by the velocimeter 220 into the second static image. Therefore, a shoot range of the static camera 210 does not need to cover a speed display device of the velocimeter 220.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A speed measurement system with dynamic image capture, comprising:
a dynamic camera adapted to continuously shoot a predetermined region to capture a first dynamic image;
a velocimeter adapted to measure a moving speed of a moving object in the predetermined region; and
an image combining unit electrically connected to the dynamic camera and the velocimeter, and the image combining unit being adapted to combine the first dynamic image and the moving speed of the moving object into a second dynamic image.

2. The speed measurement system with dynamic image capture as claimed in claim 1, further comprising:
a storage device electrically connected to the image combining unit, wherein the storage device is adapted to store the second dynamic image.

3. The speed measurement system with dynamic image capture as claimed in claim 2, further comprising:
a control unit electrically connected to the velocimeter and the storage device, wherein the control unit is adapted to turn on the storage device when the moving speed of the moving object measured by the velocimeter exceeds a predetermined value.

4. The speed measurement system with dynamic image capture as claimed in claim 1 further comprising:
a display device electrically connected to the image combining unit, wherein the display device is adapted to display the second dynamic image.

5. The speed measurement system with dynamic image capture as claimed in claim 1, further comprising:
a transmission apparatus electrically connected to the image combining unit, wherein the transmission apparatus is adapted to transmit the second dynamic image.

6. The speed measurement system with dynamic image capture as claimed in claim 5, wherein the transmission apparatus comprises a wired network apparatus or a wireless network apparatus.

7. The speed measurement system with dynamic image capture as claimed in claim 6, further comprising:
a video server electrically connected between the transmission apparatus and the image combining unit, wherein the video server is adapted to convert a signal type of the second dynamic image into a digital network signal.

8. The speed measurement system with dynamic image capture as claimed in claim 1, further comprising:
a signal converter electrically connected to the image combining unit for converting a signal type of the second dynamic image; and
a storage device electrically connected to the signal converter, wherein the storage device is adapted to store the second dynamic image.

9. The speed measurement system with dynamic image capture as claimed in claim 8, further comprising:
a control unit electrically connected to the velocimeter and the storage device, wherein the control unit is adapted to turn on the storage device when the moving speed of the moving object measured by the velocimeter exceeds a predetermined value.

10. The speed measurement system with dynamic image capture as claimed in claim 1, further comprising:
a signal converter electrically connected to the image combining unit for converting a signal type of the second dynamic image; and
a display device electrically connected to the signal converter, wherein the display device is adapted to display the second dynamic image.

11. The speed measurement system with dynamic image capture as claimed in claim 1, further comprising:
a signal converter electrically connected to the image combining unit for converting a signal type of the second dynamic image; and
a transmission apparatus electrically connected to the signal converter, wherein the transmission apparatus is adapted to transmit the second dynamic image.

12. The speed measurement system with dynamic image capture as claimed in claim 11, further comprising:
a video server electrically connected between the transmission apparatus and the signal converter, wherein the video server is adapted to convert a signal type of the second dynamic image into a digital network signal.

13. The speed measurement system with dynamic image capture as claimed in claim 1, wherein the velocimeter comprises a laser velocimeter.

14. A speed measurement system with static image capture, comprising:
a velocimeter adapted to measuring a moving speed of a moving object in a predetermined region;
a static camera electrically connected to the velocimeter, and the static camera being adapted to shoot the moving object to capture a first static image when the moving speed of the moving object measured by the velocimeter exceeding a predetermined value; and
an image combining unit electrically connected to the velocimeter and the static camera, and the image combining unit being adapted to combine the first static image and the moving speed of the moving object into a second static image.

15. The speed measurement system with static image capture as claimed in claim 14, further comprising:
a storage device electrically connected to the image combining unit, wherein the storage device is adapted to store the second static image.
